(19) United States
(12) Patent Application Publication
(10) Pub. No.: US 2018/0101541 A1
(43) Pub. Date: Apr. 12, 2018

(54) DETERMINING LOCATION INFORMATION BASED ON USER CHARACTERISTICS

(71) Applicant: Alibaba Group Holding Limited, George Town (KY)

(72) Inventors: Mingxu Shao, Hangzhou (CN); Haoyuan Pan, Hangzhou (CN); Di Xu, Hangzhou (CN); Shaoli Qian, Hangzhou (CN); Run Zou, Hangzhou (CN); Jian Kong, Hangzhou (CN); Tao Wang, Hangzhou (CN); Hui Wang, Hangzhou (CN)

(73) Assignee: Alibaba Group Holding Limited, George Town (KY)

(21) Appl. No.: 15/838,100

(22) Filed: Dec. 11, 2017

Related U.S. Application Data
(63) Continuation of application No. PCT/CN2016/084594, filed on Jun. 3, 2016.

(30) Foreign Application Priority Data
Jun. 12, 2015 (CN) 201510323607.8

(51) Int. Cl. G06F 17/30; G06F 7/08

(52) U.S. Cl. CPC G06F 17/3087; G06F 7/08; G06F 17/30321; G06F 17/30554

(57) ABSTRACT

A keyword input by a first user is received by a server. User characteristics are determined using the keyword. A first region is identified that comprises plural second regions. Based at least on location information of users in the first region, quantities of second users in respective second regions are determined that have the user characteristics. Candidate regions are determined from the plural regions based on the quantities of the second users. The candidate regions are provided for presentation to the first user.

This application is a continuation of PCT Application No. PCT/CN2016/084594, filed on Jun. 3, 2016, which claims priority to Chinese Patent Application No. 201510323607.8, filed on Jun. 12, 2015, and each application is incorporated by reference in its entirety.

### BACKGROUND

The present application relates to location determination technologies. For example, spatial location selection refers to a process of selecting a location for one or more location selection objects in a particular geographical region. During spatial location selection in conventional systems, statuses of a population in several regions are generally learned by means of a questionnaire survey. Then, the questionnaire survey is analyzed, and corresponding location information is provided for a user according to the analysis result, so as to help the user make a location selection decision. Limitations can occur, however, regarding range, quantity, and honesty degree of the questionnaire survey population, so that the existing location information providing techniques may not be accurate.

### SUMMARY

The present disclosure describes techniques for determining location information for users having the same user characteristics, which can solve the problem of situations in which location information provided for a user may not be as accurate as desired.

Quantities of users having the same user characteristics in respective second regions can be determined according to a location of a user in a region. Candidate regions can be determined from the second regions according to the quantities of users having the same user characteristics, and the candidate regions can be provided to the user. In this way, a user can intuitively know the distribution of users in respective second regions. This can overcome low accuracy that can occur in conventional systems caused by dependency, for example, on the range, quantity, and honesty degree of a questionnaire survey population, thus improving the accuracy of location information provided for the user.

In an implementation, a computer-implemented method comprises: receiving, by a server, a keyword input by a first user; determining, using at least the keyword, user characteristics; identifying a first region, the first region comprising plural second regions; determining, based at least on location information of users in the first region, quantities of second users in respective second regions that have the user characteristics; determining candidate regions from the plural regions based on the quantities of the second users; and providing the candidate regions for presentation to the first user.

Implementations of the described subject matter, including the previously described implementation, can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented in particular implementations, so as to realize one or more of the following advantages. First, data acquisition bottlenecks can be reduced as reliance on questionnaires is reduced. Second, data acquisition costs can be reduced in areas such as manpower and material resources. Third, issues regarding data timeliness and biased samples can be reduced by avoiding surveys, which may take a relatively long time to complete before the ultimate selection of the location and may further be biased due to human factors. Fourth, while online user behaviors considered in the conventional solution may be based on generally static people, techniques for the present disclosure can deal with dynamic sets of real-world people. For example, the life circle of people may change within a 24-hour period. Other advantages will be apparent to those of ordinary skill in the art.

The details of one or more implementations of the subject matter of this specification are set forth in the Detailed Description, the Claims, and the accompanying drawings. Other features, aspects, and advantages of the subject matter will become apparent from the Detailed Description, the Claims, and the accompanying drawings.

### DESCRIPTION OF DRAWINGS

FIG. 1 is a flowchart illustrating an example of a computer-implemented method for providing location information, according to an implementation of the present disclosure.

FIG. 2 is a block diagram illustrating an example of a location information providing device, according to an implementation of the present disclosure.

FIG. 3 is a flowchart illustrating an example of a computer-implemented method for generating statistics, according to an implementation of the present disclosure.

FIG. 4 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes techniques for determining location information for users having the same user characteristics, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, details unnecessary to obtain an understanding of the described subject matter can be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

In addition to factors such as geographical location, traffic conditions, and environmental conditions, human factors can also be considered in location selection. For example, techniques used in the present disclosure can employ big data technology to reduce the data acquisition cost, enhance the data timeliness, and integrate users' online and offline behaviors. This can support the selection of a location of a merchant, which can supplement conventional location selection techniques. Location selection can be based, for example, on a common offline location of a mobile Internet user in combination with online behavior characteristics the user.

The present application provides a solution of providing location information for a user according to locations and user characteristics of users in a region. This can avoid the problem of low accuracy of a location information providing solution in conventional systems and improve the accuracy of location information provided for a user.

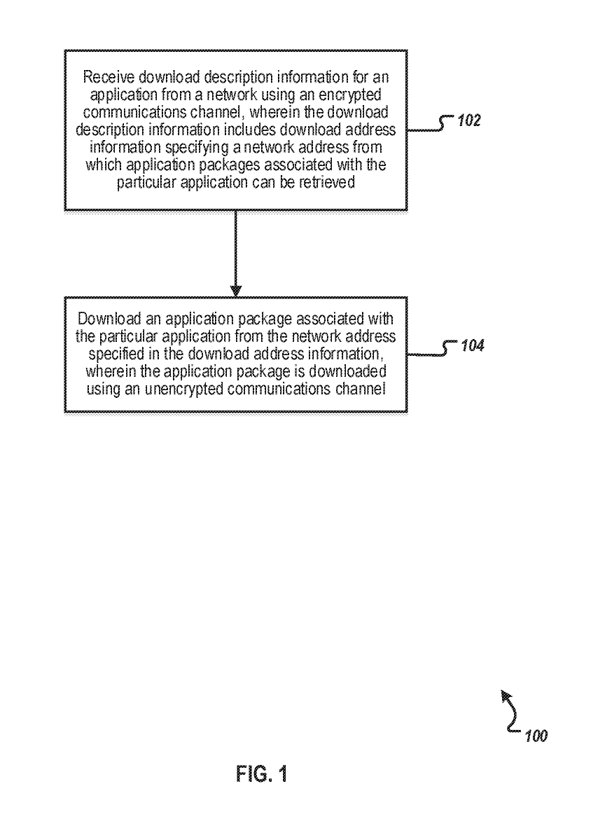

FIG. 1 is a flowchart illustrating an example of a computer-implemented method 100 for providing location information, according to an implementation of the present disclosure. For clarity of presentation, the description that follows generally describes method 100 in the context of the other figures in this description. However, it will be understood that method 100 can be performed, for example, by any system, environment, software, and hardware, or a combination of systems, environments, software, and hardware, as appropriate. In some implementations, various steps of method 100 can be run in parallel, in combination, in loops, or in any order.

At 102, a keyword input by a first user is received by a server. The first user can be, for example, a user having a spatial location selection requirement, such as within an application that the first user is using or on a web site. In another example, the first user can be a merchant who needs to make or identify a selection of a business location or a business region for a potential or proposed business of the merchant. For example, the merchant may be starting their own business and needs to select a best location for the business. The server can receive the keyword input, for example, through a location information request message from a client terminal or through a mobile device. For example, the request message can be a keyword input by the first user on the client terminal. In another, the server can directly receive the keyword input by the first user through an input/output device of the server. In other examples, the first user can directly input the keyword in an input field, or the user can select from options provided on a page within an application. From 102, method 100 proceeds to 104.

At 104, user characteristics are determined using at least the keyword. The user characteristics can be determined, for example, if the keyword input by the user is consistent with the user characteristics pre-stored in the server. In another example, the user characteristics can be determined directly in other ways. If the keyword input by the user is inconsistent with the user characteristics pre-stored in the server, for example, the user characteristics can be determined according to a corresponding relationship between keywords and user characteristics. The corresponding relationship can be pre-stored, or the relationship can be obtained by the server from a network. In some implementations, the user characteristics can include character keywords of the first user, including demographics, such as the user's profession, age, consumption level, and consumption time period. From 104, method 100 proceeds to 106.

At 106, a first region that comprises plural second regions is identified. For example, the first region can be determined according to current location information of the first user, such as based on a global positioning system (GPS) location. In another example, the first region can be determined based on a region input by the first user, such as the name of a city, country, or region. In another example, region options can be provided for the user, and the first region can be determined according to a selection of the user. For example, according to an internet protocol (IP) address of the user that is discovered when the first user surfs the Internet, a determination can be made that the first user is in Beijing, and then the first region can be determined to be Beijing. In another example, a mobile phone number of the first user can be determined based on a login account of the first user. Then, based on a location where the number accesses a mobile network, such as indicating that the first user is currently located in Hangzhou, a determination can be made that the first region is Hangzhou. In another example, if the user inputs “Chengdu”, then a determination can be made that the first region is Chengdu. From 106, method 100 proceeds to 108.

At 108, quantities of second users in respective second regions that have the user characteristics are determined based at least on location information of users in the first region. In some implementations, in order to make the data for analysis more accurate, the quantities of second users that are determined can be based on data corresponding to a latest or predetermined period of time. The predetermined period of time can be, for example, the latest month, the latest two months, or some other time period that can be set according to a specific requirement or a specific data acquisition situation. In some implementations, the locations of the users in the first region can be acquired according to user location information obtained from networks accessed by the users in the first region, or the location information can be acquired according to applications that the users log onto. In some implementations, determining second regions can be completed, at least in part, and the information can be stored before the receipt of keywords input by first users. In some implementations, determining second regions can be completed, at least in part, after the first region is determined and before the quantities of second users having the user characteristics in respective second regions in the first region are determined. From 108, method 100 proceeds to 110.

At 110, candidate regions are determined from the multiple plural regions based on the quantities of the second users. For example, the candidate regions can be determined from the plural second regions based on the quantities of the second users that are ranked according to the quantities of the second users, with the top-ranked regions being used as the candidate regions. In another example, second regions can be designated as candidate regions when the quantities of the second users are greater than a predetermined numerical value (or threshold). From 110, method 100 proceeds to 112.

At 112, the candidate regions are provided for presentation to the first user. For example, the candidate regions can be provided in text form, such as in a list of recommended regions. In another example, the candidate regions can be provided to the user more intuitively, for example, graphically, such as highlighted on a map. In some implementations, a region with a larger number of second users can have a darker color or a lower transparency, and a region with a smaller number of second users can have a lighter color or a higher transparency. After 112, method 100 stops.

In some implementations, pre-excluded location input by the user can further be removed before the candidate regions are provided to the first user. As part of location preferences, (for example, such as part of user preferences or a user profile), the user can input (or identify) plural second regions in which the user is not interested (and to which no attention needs to be paid). In this case, before the candidate regions are provided for the first user, the second regions to which the user does not need to pay attention can be excluded from the candidate regions. As a result, the location information provided to the user can better meet the user requirements or improve the user's experience.

In an example, a user who already owns a fancy café at location A in Beijing may also want to open a chain store. While the user is located in Hangzhou, for example, the user can select “Beijing” as the first region in a user interface. After inputting user characteristics such as “white collar” and “high-frequency mid-amount,” the user can also input a pre-excluded location A and select an area having a 2-kilometer radius around A as a coverage of A, such as to identify a regional customer base. After data processing and sorting are performed, four second regions that include second regions B, C, D, and E (but not A) can be determined as the candidate regions. The candidate regions can be presented to the user, for example, as regions that are highlighted on the map of Beijing, such as to serve as a visual reference for location selection.

In some implementations, the quantities of users having the user characteristics in second regions can be determined according to a location of a user in a region. For example, candidate regions can be determined according to the greatest quantities of users having the user characteristics. In this way, a user can intuitively know the distribution of users in the second regions.

In some implementations, method 100 can further include dividing the first region into plural second regions according to a predetermined rule, acquiring locations of all third users in the first region within a predetermined period of time, and acquiring user characteristics of all the third users in the first region within the predetermined period of time. In some implementations, the division of the first region into plural second regions according to the predetermined rule can include dividing the first region according to a predetermined region size. For example, region sizes can be limited to areas that are J meters by K meters (or some other size or dimensions), and the collected user location information can be converted into a longitude- and latitude-based regions. Then, the regions can be converted into a corresponding second region using an application of a geographical location service provider, such as an interface provided by AutoNavi company. In another example, regional division can be based on a population density. For example, a region with a relatively high population density (such as downtown) can be further divided by using a relatively small region size. Otherwise, in an area with a relatively low population density (such as a suburb), the region can be divided by using a relatively large region size.

In some implementations, the location of the user can be acquired based on a network that the user accesses. In some implementations, the location of the user can be acquired according to an application that the user logs onto.

In some implementations, in order to improve a response speed of providing location information for the user, regional divisions can be completed before the keyword input by the user is received. For example, the first region can be divided into plural second regions in advance according to a predetermined rule (such as region size, population density, regional age, regional gender, and regional product penetration). Also, the locations of all the third users in the first region within the predetermined period of time can be acquired. In this way, after the keyword is received and the first region and user characteristics are determined, the quantities of users having the user characteristics in the second regions can be acquired quickly. In addition, the second regions can be sorted according to the quantities, and the location information can be provided to the user rapidly, thus improving user experience.

In some implementations, acquiring locations of third users in the first region within a predetermined period of time can include the use of login information. For example, plural second regions can be acquired for which the third users in the first region are located when logging onto a predetermined application within the predetermined period of time. The numbers of times each of the third users log onto the application in respective second regions can be counted. Then, the location of a third user can be determined based on a second region in which the third user logs onto the application for the largest number of times.

In some implementations, a region in which each user logs onto a predetermined application for the largest number of times can be considered a life circle of the user in a recent period of time. In some implementations, a user characteristic input by the first user further can include a time-period characteristic of the user in daytime or at night. Then, when the number of times the user logs onto the predetermined application in each region is acquired, a specific time period in which the user logs onto the predetermined application in each region can be determined. The predetermined application can be, for example, any application having a location acquisition service function, such as ALIPAY, QQ, WEIBO, or WECHAT. This information can be used to determine the number of times the user logs onto the application in daytime in each region, the number of times the user logs onto the application at night in each region, and the number of times the user logs onto the application in each region. Finally, a second region in which each user logs onto the application for the largest number of times can be used as the location of the user. In some implementations, a second region in which each user logs onto the application for the largest number of times in the daytime can be used as the daytime location of the user, and a second region in which each user logs onto the application for the largest number of times at night can be used as the nighttime location of the user.

In some implementations, in order to determine the number of times the third user logs onto a predetermined application in the predetermined period of time, a corresponding relationship can be determined between the third user and the predetermined application. The relationship can be determined, for example, using a corresponding relationship between an ID for logging onto the application and a mobile phone number of the user. The relationship can also be determined, for example, using a corresponding relationship between an IP address used by the user to log onto the application and an IP address of a user equipment.

In some implementations, acquiring user characteristics of all the third users in the first region within the predetermined period of time can include acquiring network information of the third users in the first region and determining the user characteristics of the third users according to the network information. The user characteristics of the third user can be determined or inferred, for example, using user information of the predetermined application that the user logs onto. The user information can include, for example, age, gender, and birthday, and can further include user information determined from an instant messaging tool (such as QQ). Determined or inferred information can indicate, for example that the user is a college student/white-collar worker, such as based on an address of the user that is common to a college/office building. In another example, it can be determined or inferred that a consumption characteristic of the user is high-frequency or a high-amount purchaser, such as based on the shopping frequency and amount of the user.

In some implementations, determining the quantities of second users having the user characteristics in respective second regions can include, for example, determining the third users whose locations are in respective second regions, screening out second users having the user characteristics from the third users, and counting the quantities of the second users. In some implementations, determining candidate regions from the plural second regions according to the quantities of the second users can include, for example, determining index values of the user characteristics in respective second regions according to the quantities of the second users, sorting the plural second regions according to the index values, and using the top M second regions as the candidate regions, where M is a predetermined numerical value.

In some implementations, determining index values of the user characteristics in respective second regions according to the quantities of the second users can include sorting the second regions according to an ascending order of the quantities of the second users. Sequence numbers from 1 to N can then be assigned to the regions, where N is a positive integer greater than
1. Sequence number values corresponding to respective second regions can be determined, for example, using the following formula:

sequence number value=(sequence number of each second region/the total number of second regions−0.5)*2.

Index values corresponding to respective second regions can then be determined using the following formula:

index value=round((ASIN(sequence number value)/π+0.5)*1000).

In some implementations, in order to avoid statistical variations, before the second regions are sorted according to an ascending order of the quantities of the second users, some of the second regions can be eliminated, such as second regions in which the user quantities are less than a predetermined numerical value (such as 100). The quantities of users having the specified user characteristics can be converted into indexes in the range of [0-100], such that the occurrences of the indexes approximately meet a normal distribution.

In some implementations, the quantity of users meeting a tag condition in a region can be converted into an index ranging from 0 to 100. In this way, sensitive user quantity data can be avoided without affecting the sequence of the quantities of second users in the regions. Further, the quantities of users having the specified user characteristics can be converted into regional indexes. In this way, the number of calculations that need to be completed can be reduced, and calculations on user-level data can be avoided. Doing so can increase the response time of providing location information for the user, which can improve the user experience.

In some implementations, the first user can input multiple user characteristics. In some implementations, determining the quantities of second users having the user characteristics in respective second regions can include, for example, determining the quantities of plural second users having the user characteristics in respective second regions. In some implementations, sorting the plural second regions according to the quantities of the second users can include, for example, separately determining an index value of each user characteristic in respective second regions according to the quantities of the plural second users. Then, comprehensive index values of respective second regions can be determined based on the index values of the user characteristics and weights preset for the respective user characteristics.

In some implementations, the comprehensive index value=a*X1+b*X2+c*X3 . . . , wherein X1, X2, X3 . . . are index values of respective user characteristics, and where a, b, c . . . are weights of respective user characteristics. The plural second regions can be sorted based on the comprehensive index values.

In some implementations, preset weights can be set by the first user, and default weights can be used in some circumstances. For example, a mean weight can be used for the user characteristics, or an empirical weight can be used for the user characteristics.

In some implementations, the quantities of users having the user characteristics in second regions can be determined based on a location of a user in a region. Candidate regions that are determined based on the quantities of users having the user characteristics can be provided for presentation to the user. In this way, the user can intuitively know the distribution of users in the second regions.

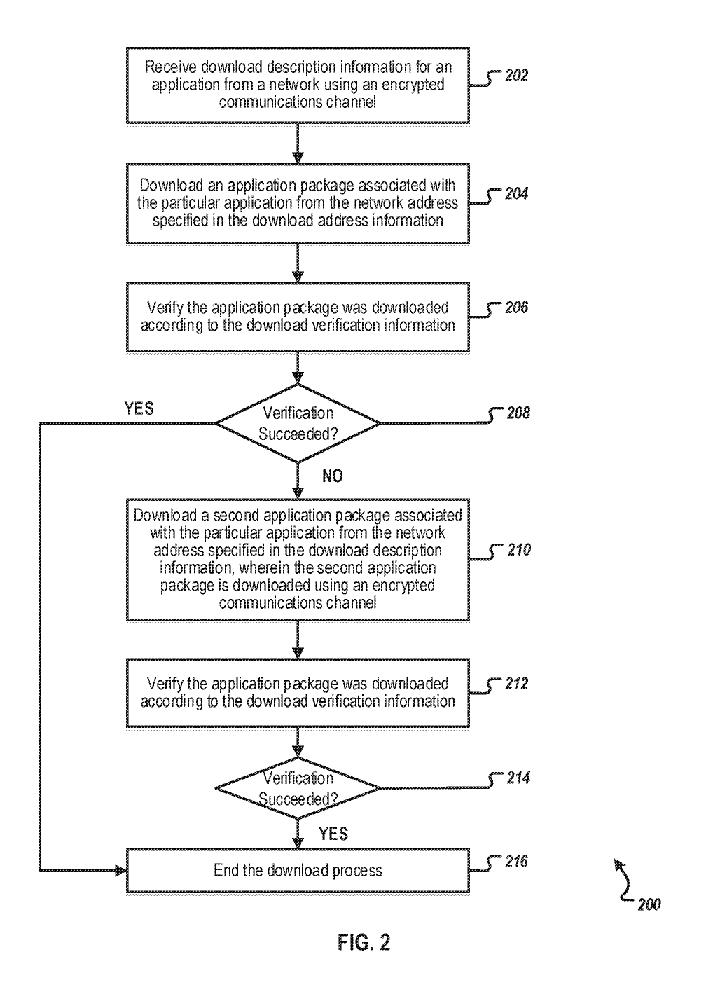

FIG. 2 is a block diagram illustrating an example of a location information providing device 200, according to an implementation of the present disclosure. The location information providing device 200 can be applied to a server and can include the following modules. A receiving module 202 can be configured to receive a keyword input by a first user. A characteristic determination module 203 can be configured to determine a user characteristic according to the keyword. A first region determination module 204 can be configured to determine a first region. The first region can include plural second regions. A user quantity determination module 206 can be configured to determine, according to location information of users in the first region, the quantities of second users having the user characteristics in respective second regions. A candidate region determination module 208 can be configured to determine candidate regions from the plural second regions according to the quantities of the second users. A result feedback module 210 can be configured to provide the candidate regions for the first user.

In some implementations, the receiving module 202 and the result feedback module 210 can be located on a client terminal. The first region determination module 204 can be located on the client terminal or a server terminal. The user quantity determination module 206 and the candidate region determination module 208 can be located on the server terminal.

In some implementations, the location information providing device 200 can further include the following modules. A region division module can be configured to divide the first region into plural second regions according to a predetermined rule. A location acquisition module can be configured to acquire locations of all third users in the first region within a predetermined period of time. A user characteristics acquisition module can be configured to acquire user characteristics of all the third users in the first region within the predetermined period of time. In some implementations, the location acquisition module can include sub-modules configured to acquire plural second regions.

In some implementations, the user characteristics acquisition module can include a network information acquisition sub-module configured to acquire network information of the third users in the first region and a user characteristics determination sub-module configured to determine the user characteristics of the third users according to the network information. In some implementations, the user quantity determination module can include a user determination sub-module configured to determine the third users whose locations are in respective second regions and a user quantity determination sub-module configured to screen out second users having the user characteristics from the third users and to count the quantities of the second users.

In some implementations, the candidate region determination module can include the following sub-modules. A first index value determination sub-module can be configured to determine index values of the user characteristics in respective second regions according to the quantities of the second users. An index value sorting sub-module can be configured to sort the plural second regions according to the index values. A candidate region determination sub-module can be configured to use the top M second regions as the candidate regions, where M is a predetermined numerical value.

In some implementations, the first index value determination sub-module can include the following sub-modules. A sorting sub-module can be configured to sort the second regions according to an ascending order of the quantities of the second users, and sequentially assign sequence numbers from 1 to N, wherein N is a positive integer greater than 1. A sequence number value determination sub-module can be configured to determine sequence number values corresponding to respective second regions according to the following formula:

the sequence number value=(the sequence number of each second region/the total number of second regions−0.5)*2.

An index value determination sub-module can be configured to determine index values corresponding to respective second regions according to the following formula:

the index value=round((ASIN(sequence number value)/π+0.5)*1000).

In some implementations, multiple user characteristics can be used. The user quantity determination module can be configured to determine the quantities of plural second users having the user characteristics in respective second regions.

In some implementations, the sorting module can include the following sub-modules. A second index determination sub-module can be configured to separately determine an index value of each user characteristic in respective second regions according to the quantities of the plural second users. A comprehensive index value determination sub-module can be configured to determine comprehensive index values of respective second regions according to the index values of the user characteristics and weights preset for the respective user characteristics: the comprehensive index value=a*X1+b*X2+c*X3 . . . , wherein X1, X2, X3 . . . are index values of respective user characteristics; and a, b, c . . . are weights of respective user characteristics. A comprehensive index value sorting sub-module can be configured to sort the plural second regions according to the comprehensive index values.

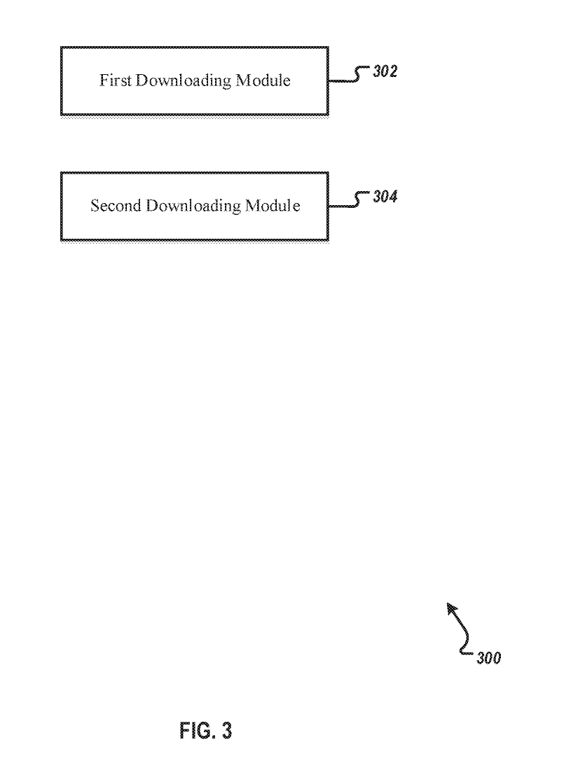

FIG. 3 is a flowchart illustrating an example of a computer-implemented method 300 for generating statistics, according to an implementation of the present disclosure. For clarity of presentation, the description that follows generally describes method 300 in the context of the other figures in this description. However, it will be understood that method 300 can be performed, for example, by any system, environment, software, and hardware, or a combination of systems, environments, software, and hardware, as appropriate. In some implementations, various steps of method 300 can be run in parallel, in combination, in loops, or in any order.

At 302, statistics are generated about a location where a population most usually appears within a recent time period. For example, the statistics can include historical information regarding the actions of users in a certain area (such as a city, or a region of a city) in the last several days. From 302, method 300 proceeds to 304.

At 304, common offline locations of users in the population are determined according to the location and a corresponding region. For example, in addition to the generated statistics, information regarding the offline locations of the users can be determined on a region-by-region basis. From 304, method 300 proceeds to 306.

At 306, a population characteristic is received that has been input by a location selection user. The population characteristic can include a user tag, such as a daytime tag or a nighttime tag according to a user requirement, or may not include daytime and night tags. From 306, method 300 proceeds to 308.

At 308, the quantities of users having various types of tags are counted in each region. For example, the quantities of users having the user characteristics in second regions can be determined based on a location of a user in a region and the user characteristics. The second regions can further be sorted based on the quantities of users having the user characteristics. The sorted result of the plural second regions can be provided for presentation to the user. In this way, a user can intuitively know the distribution of users in the second regions. From 308, method 300 proceeds to 310.

At 310, region data is converted into region indexes. For example, indexing can be established on the regional data so as to support rapid access and use of the regional data. From 310, method 300 proceeds to 312.

At 312, weights of the indexes are set. For example, higher weights can be assigned to regions in which there are greater numbers of second users. From 312, method 300 proceeds to 314.

At 314, comprehensive indexes of the regions are obtained. For example, comprehensive indexes can be determined as a function of the indexes and the respective weights. From 314, method 300 proceeds to 316.

At 316, several regions having the largest comprehensive indexes are provided for the location selection user as candidate locations. For example, highest-ranked regions, based on the comprehensive indexes, can be provided for presentation to the user. After 316, method 300 stops.

An example is provided in which an application (such as ALIPAY) is used. First, the longitude and latitude of a user are collected by using a mobile device of the user. Second, a corresponding relationship between the mobile device of the user and a user ID (for the application) is acquired. Third, the longitude and latitude data are converted into a region ID according to a map utility or map interface (such as AMAP), and a corresponding relationship between the user ID and the region ID is acquired. Fourth, the number of times each user appears on each region ID in each time period within the last 30 days is counted. Fifth, the number of times each user appears on each region ID in the day time, the number of times each user appears on each region ID at night, and the total number of times each user appears on each region ID are counted.

Sixth, regions in which each user appears for the largest number of times are separately taken as a daytime region ID, a night region ID, and a common region ID of the user. Seventh, a location selection user inputs a population characteristic, such as a user tag. Eighth, the quantity of users meeting the user tag is counted in each region. Ninth, a determination is made whether the quantity of users meeting the user tag in each region is greater than a threshold (such as 100). If the threshold is not met, then the region in which the quantity of users is less than the threshold is eliminated. For regions meeting the threshold, the regions are sorted by ascending order of the counts of users, and sequence numbers from 1 to N are assigned, where N is the number of regions meeting the threshold. Tenth, sequence number values of the regions are calculated as: sequence number value=(region's sequence number/total number of regions−0.5)*2.

Eleventh, index values of the regions are calculated, where index value=round((ASIN(sequence number value)/π+0.5)*1000). Twelfth, an index region render graph is displayed on the map according to the index values, such as to present the information visually for the user.

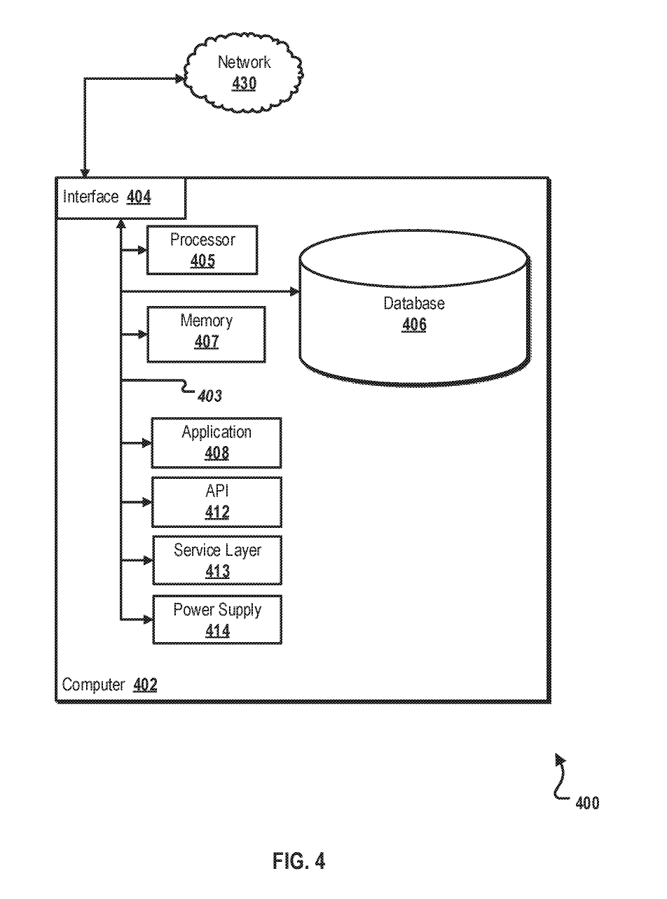

FIG. 4 is a block diagram illustrating an example of a computer-implemented system 400 used to provide computational functionalities associated with described algorithms, methods, functions, processes, flows, and procedures, according to an implementation of the present disclosure. In the illustrated implementation, system 400 includes a computer 402 and a network 430.

The illustrated computer 402 is intended to encompass any computing device such as a server, desktop computer, laptop/notebook computer, wireless data port, smart phone, personal data assistant (PDA), tablet computer, one or more processors within these devices, another computing device, or a combination of computing devices, including physical or virtual instances of the computing device, or a combination of physical or virtual instances of the computing device. Additionally, the computer 402 can include an input device, such as a keypad, keyboard, touch screen, another input device, or a combination of input devices that can accept user information, and an output device that conveys information associated with the operation of the computer 402, including digital data, visual, audio, another type of information, or a combination of types of information, on a graphical-type user interface (UI) (or GUI) or other UI.

The computer 402 can serve in a role in a distributed computing system as a client, network component, a server, a database or another persistency, another role, or a combination of roles for performing the subject matter described in the present disclosure. The illustrated computer 402 is communicably coupled with a network 430. In some implementations, one or more components of the computer 402 can be configured to operate within an environment, including cloud-computing-based, local, global, another environment, or a combination of environments.

At a high level, the computer 402 is an electronic computing device operable to receive, transmit, process, store, or manage data and information associated with the described subject matter. According to some implementations, the computer 402 can also include or be communicably coupled with a server, including an application server, e-mail server, web server, caching server, streaming data server, another server, or a combination of servers.

The computer 402 can receive requests over network 430 (for example, from a client software application executing on another computer 402) and respond to the received requests by processing the received requests using a software application or a combination of software applications. In addition, requests can also be sent to the computer 402 from internal users (for example, from a command console or by another internal access method), external or third-parties, or other entities, individuals, systems, or computers.

Each of the components of the computer 402 can communicate using a system bus 403. In some implementations, any or all of the components of the computer 402, including hardware, software, or a combination of hardware and software, can interface over the system bus 403 using an application programming interface (API) 412, a service layer 413, or a combination of the API 412 and service layer 413. The API 412 can include specifications for routines, data structures, and object classes. The API 412 can be either computer-language independent or dependent and refer to a complete interface, a single function, or even a set of APIs. The service layer 413 provides software services to the computer 402 or other components (whether illustrated or not) that are communicably coupled to the computer 402. The functionality of the computer 402 can be accessible for all service consumers using this service layer. Software services, such as those provided by the service layer 413, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 402, alternative implementations can illustrate the API 412 or the service layer 413 as stand-alone components in relation to other components of the computer 402 or other components (whether illustrated or not) that are communicably coupled to the computer 402. Moreover, any or all parts of the API 412 or the service layer 413 can be implemented as a child or a sub-module of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402. The interface 404 is used by the computer 402 for communicating with another computing system (whether illustrated or not) that is communicatively linked to the network 430 in a distributed environment. Generally, the interface 404 is operable to communicate with the network 430 and includes logic encoded in software, hardware, or a combination of software and hardware. More specifically, the interface 404 can include software supporting one or more communication protocols associated with communications such that the network 430 or interface's hardware is operable to communicate physical signals within and outside of the illustrated computer 402.

The computer 402 includes a processor 405. Although illustrated as a single processor 405 in FIG. 4, two or more processors can be used according to particular needs, desires, or particular implementations of the computer 402. Generally, the processor 405 executes instructions and manipulates data to perform the operations of the computer 402 and any algorithms, methods, functions, processes, flows, and procedures as described in the present disclosure.

The computer 402 also includes a database 406 that can hold data for the computer 402, another component communicatively linked to the network 430 (whether illustrated or not), or a combination of the computer 402 and another component. For example, database 406 can be an in-memory, conventional, or another type of database storing data consistent with the present disclosure. In some implementations, database 406 can be a combination of two or more different database types (for example, a hybrid in-memory and conventional database) according to particular needs, desires, or particular implementations of the computer 402 and the described functionality. Although illustrated as a single database 406 in FIG. 4, two or more databases of similar or differing types can be used according to particular needs, desires, or particular implementations of the computer 402 and the described functionality. While database 406 is illustrated as an integral component of the computer 402, in alternative implementations, database 406 can be external to the computer 402.

The computer 402 also includes a memory 407 that can hold data for the computer 402, another component or components communicatively linked to the network 430 (whether illustrated or not), or a combination of the computer 402 and another component. Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 or similar or differing types can be used according to particular needs, desires, or particular implementations of the computer 402 and the described functionality. While memory 407 is illustrated as an integral component of the computer 402, in alternative implementations, memory 407 can be external to the computer 402.

The application 408 is an algorithmic software engine providing functionality according to particular needs, desires, or particular implementations of the computer 402, particularly with respect to functionality described in the present disclosure. For example, application 408 can serve as one or more components, modules, or applications. Further, although illustrated as a single application 408, the application 408 can be implemented as multiple applications 408 on the computer 402. In addition, although illustrated as integral to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion or management circuits (including recharging, standby, or another power management functionality). In some implementations, the power-supply 414 can include a power plug to allow the computer 402 to be plugged into a wall socket or another power source to, for example, power the computer 402 or recharge a rechargeable battery.

There can be any number of computers 402 associated with, or external to, a computer system containing computer 402, each computer 402 communicating over network 430. Further, the term “client,” “user,” or other appropriate terminology can be used interchangeably, as appropriate, without departing from the scope of the present disclosure. Moreover, the present disclosure contemplates that many users can use one computer 402, or that one user can use multiple computers 402.

Described implementations of the subject matter can include one or more features, alone or in combination.

For example, in a first implementation, a computer-implemented method comprising: receiving, by a server, a keyword input by a first user; determining, using at least the keyword, user characteristics; identifying a first region, the first region comprising plural second regions; determining, based at least on location information of users in the first region, quantities of second users in respective second regions that have the user characteristics; determining candidate regions from the plural regions based on the quantities of the second users; and providing the candidate regions for presentation to the first user.

The foregoing and other described implementations can each, optionally, include one or more of the following features:

A first feature, combinable with any of the following features, the computer-implemented method further comprising: dividing, before determining the quantities of second users having the user characteristics in the respective second regions, the first region into plural second regions according to a predetermined rule; acquiring locations of all third users in the first region within a predetermined period of time; and acquiring user characteristics of all the third users in the first region within the predetermined period of time.

A second feature, combinable with any of the previous or following features, wherein acquiring locations of all third users in the first region within a predetermined period of time comprises: acquiring plural second regions, including locating the third users in the first region based on when the third users log into a predetermined application within the predetermined period of time and the numbers of times each of the third users logs into the application in respective second regions; and using, as the location of the third user, a second region in which one third user logs onto the application for the largest number of times.

A third feature, combinable with any of the previous or following features, wherein acquiring user characteristics of all the third users in the first region within the predetermined period of time comprises: acquiring network information of the third users in the first region; and determining the user characteristics of the third users according to the network information.

A fourth feature, combinable with any of the previous or following features, wherein determining the quantities of second users having the user characteristics in respective second regions comprises: determining the third users whose locations are in respective second regions; screening out second users having the user characteristics from the third users; and counting the quantities of the second users.

A fifth feature, combinable with any of the previous or following features, wherein determining candidate regions from the plural second regions according to the quantities of the second users comprises: determining index values of the user characteristics in respective second regions according to the quantities of the second users; sorting the plural second regions according to the index values; and using a top M second regions as the candidate regions, M being a predetermined numerical value.

A sixth feature, combinable with any of the previous or following features, wherein determining index values of the user characteristics in respective second regions according to the quantities of the second users comprises: sorting the second regions according to an ascending order of the quantities of the second users, and sequentially assigning sequence numbers from 1 to N, wherein N is a positive integer greater than 1; determining sequence number values corresponding to respective second regions according to the following formula: the sequence number value=(the sequence number of each second region/the total number of second regions−0.5)*2; and determining index values corresponding to respective second regions according to the following formula: the index value=round((ASIN(sequence number value)/π+0.5)*1000).

A seventh feature, combinable with any of the previous or following features, wherein there are multiple user characteristics, wherein determining the quantities of second users having the user characteristics in respective second regions comprises determining the quantities of plural second users having the user characteristics in respective second regions, and wherein sorting the plural second regions according to the quantities of the second users comprises separately determining an index value of each user characteristic in respective second regions according to the quantities of the plural second users, and wherein the computer-implemented method further comprises: determining comprehensive index values of respective second regions according to the index values of the user characteristics and weights preset for the respective user characteristics: the comprehensive index value=a*X1+b*X2+c*X3 . . . , wherein X1, X2, X3 . . . are index values of respective user characteristics, and wherein a, b, c . . . are weights of respective user characteristics; and sorting the plural second regions according to the comprehensive index values.

In a second implementation, a non-transitory, computer-readable medium storing one or more instructions executable by a computer system to perform operations comprising: receiving, by a server, a keyword input by a first user; determining, using at least the keyword, user characteristics; identifying a first region, the first region comprising plural second regions; determining, based at least on location information of users in the first region, quantities of second users in respective second regions that have the user characteristics; determining candidate regions from the plural regions based on the quantities of the second users; and providing the candidate regions for presentation to the first user.

The foregoing and other described implementations can each, optionally, include one or more of the following features:

A first feature, combinable with any of the following features, the operations further comprising: dividing, before determining the quantities of second users having the user characteristics in the respective second regions, the first region into plural second regions according to a predetermined rule; acquiring locations of all third users in the first region within a predetermined period of time; and acquiring user characteristics of all the third users in the first region within the predetermined period of time.

A second feature, combinable with any of the previous or following features, wherein acquiring locations of all third users in the first region within a predetermined period of time comprises: acquiring plural second regions, including locating the third users in the first region based on when the third users log into a predetermined application within the predetermined period of time and the numbers of times each of the third users logs into the application in respective second regions; and using, as the location of the third user, a second region in which one third user logs onto the application for the largest number of times.

A third feature, combinable with any of the previous or following features, wherein acquiring user characteristics of all the third users in the first region within the predetermined period of time comprises: acquiring network information of the third users in the first region; and determining the user characteristics of the third users according to the network information.

A fourth feature, combinable with any of the previous or following features, wherein determining the quantities of second users having the user characteristics in respective second regions comprises: determining the third users whose locations are in respective second regions; screening out second users having the user characteristics from the third users; and counting the quantities of the second users.

A fifth feature, combinable with any of the previous or following features, wherein determining candidate regions from the plural second regions according to the quantities of the second users comprises: determining index values of the user characteristics in respective second regions according to the quantities of the second users; sorting the plural second regions according to the index values; and using a top M second regions as the candidate regions, M being a predetermined numerical value.

A sixth feature, combinable with any of the previous or following features, wherein determining index values of the user characteristics in respective second regions according to the quantities of the second users comprises: sorting the second regions according to an ascending order of the quantities of the second users, and sequentially assigning sequence numbers from 1 to N, wherein N is a positive integer greater than 1; determining sequence number values corresponding to respective second regions according to the following formula: the sequence number value=(the sequence number of each second region/the total number of second regions−0.5)*2; and determining index values corresponding to respective second regions according to the following formula: the index value=round((ASIN(sequence number value)/π+0.5)*1000).

A seventh feature, combinable with any of the previous or following features, wherein there are multiple user characteristics, wherein determining the quantities of second users having the user characteristics in respective second regions comprises determining the quantities of plural second users having the user characteristics in respective second regions, and wherein sorting the plural second regions according to the quantities of the second users comprises separately determining an index value of each user characteristic in respective second regions according to the quantities of the plural second users, and wherein operations further comprise: determining comprehensive index values of respective second regions according to the index values of the user characteristics and weights preset for the respective user characteristics: the comprehensive index value=a*X1+b*X2+c*X3 . . . , wherein X1, X2, X3 . . . are index values of respective user characteristics, and wherein a, b, c . . . are weights of respective user characteristics; and sorting the plural second regions according to the comprehensive index values.

In a third implementation, a computer-implemented system, comprising: one or more computers and one or more computer memory devices interoperably coupled with the one or more computers and having tangible, non-transitory, machine-readable media storing one or more instructions that, when executed by the one or more computers, perform one or more operations comprising: receiving, by a server, a keyword input by a first user; determining, using at least the keyword, user characteristics; identifying a first region, the first region comprising plural second regions; determining, based at least on location information of users in the first region, quantities of second users in respective second regions that have the user characteristics; determining candidate regions from the plural regions based on the quantities of the second users; and providing the candidate regions for presentation to the first user.

The foregoing and other described implementations can each, optionally, include one or more of the following features:

A first feature, combinable with any of the following features, the operations further comprising: dividing, before determining the quantities of second users having the user characteristics in the respective second regions, the first region into plural second regions according to a predetermined rule; acquiring locations of all third users in the first region within a predetermined period of time; and acquiring user characteristics of all the third users in the first region within the predetermined period of time.

A second feature, combinable with any of the previous or following features, wherein acquiring locations of all third users in the first region within a predetermined period of time comprises: acquiring plural second regions, including locating the third users in the first region based on when the third users log into a predetermined application within the predetermined period of time and the numbers of times each of the third users logs into the application in respective second regions; and using, as the location of the third user, a second region in which one third user logs onto the application for the largest number of times.

A third feature, combinable with any of the previous or following features, wherein acquiring user characteristics of all the third users in the first region within the predetermined period of time comprises: acquiring network information of the third users in the first region; and determining the user characteristics of the third users according to the network information.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special purpose logic circuitry, for example, a central processing unit (CPU), an FPGA (field programmable gate array), or an ASIC (application-specific integrated circuit). In some implementations, the computer or computer-implemented system or special purpose logic circuitry (or a combination of the computer or computer-implemented system and special purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what can be claimed, but rather as descriptions of features that can be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
receiving, by a server, a keyword input by a first user;
determining, using at least the keyword, user characteristics;
identifying a first region, the first region comprising plural second regions;
determining, based at least on location information of users in the first region, quantities of second users in respective second regions that have the user characteristics;
determining candidate regions from the plural regions based on the quantities of the second users; and
providing the candidate regions for presentation to the first user.

2. The computer-implemented method of claim 1, further comprising:
dividing, before determining the quantities of second users having the user characteristics in the respective second regions, the first region into plural second regions according to a predetermined rule;
acquiring locations of all third users in the first region within a predetermined period of time; and
acquiring user characteristics of all the third users in the first region within the predetermined period of time.

3. The computer-implemented method of claim 2, wherein acquiring locations of all third users in the first region within a predetermined period of time comprises:
acquiring plural second regions, including locating the third users in the first region based on when the third users log into a predetermined application within the predetermined period of time and the numbers of times each of the third users logs into the application in respective second regions; and
using, as the location of the third user, a second region in which one third user logs onto the application for the largest number of times.

4. The computer-implemented method of claim 2, wherein acquiring user characteristics of all the third users in the first region within the predetermined period of time comprises:
acquiring network information of the third users in the first region; and
determining the user characteristics of the third users according to the network information.

5. The computer-implemented method of claim 4, wherein determining the quantities of second users having the user characteristics in respective second regions comprises:
determining the third users whose locations are in respective second regions;
screening out second users having the user characteristics from the third users; and
counting the quantities of the second users.

6. The computer-implemented method of claim 1, wherein determining candidate regions from the plural second regions according to the quantities of the second users comprises:
determining index values of the user characteristics in respective second regions according to the quantities of the second users;
sorting the plural second regions according to the index values; and
using a top M second regions as the candidate regions, M being a predetermined numerical value.

7. The computer-implemented method of claim 6, wherein determining index values of the user characteristics in respective second regions according to the quantities of the second users comprises:
sorting the second regions according to an ascending order of the quantities of the second users, and sequentially assigning sequence numbers from 1 to N, wherein N is a positive integer greater than 1;
determining sequence number values corresponding to respective second regions according to the following formula: the sequence number value=(the sequence number of each second region/the total number of second regions−0.5)*2; and
determining index values corresponding to respective second regions according to the following formula: the index value=round((ASIN(sequence number value)/π+0.5)*1000).

8. The computer-implemented method of claim 1, wherein there are multiple user characteristics, wherein determining the quantities of second users having the user characteristics in respective second regions comprises determining the quantities of plural second users having the user characteristics in respective second regions, and wherein sorting the plural second regions according to the quantities of the second users comprises separately determining an index value of each user characteristic in respective second regions according to the quantities of the plural second users, and wherein the computer-implemented method further comprises:
determining comprehensive index values of respective second regions according to the index values of the user characteristics and weights preset for the respective user characteristics: the comprehensive index value=a*X1+b*X2+c*X3 . . . , wherein X1, X2, X3 . . . are index values of respective user characteristics, and wherein a, b, c . . . are weights of respective user characteristics; and
sorting the plural second regions according to the comprehensive index values.

9. A non-transitory, computer-readable medium storing one or more instructions executable by a computer system to perform operations comprising:
receiving, by a server, a keyword input by a first user;
determining, using at least the keyword, user characteristics;
identifying a first region, the first region comprising plural second regions;
determining, based at least on location information of users in the first region, quantities of second users in respective second regions that have the user characteristics;
determining candidate regions from the plural regions based on the quantities of the second users; and
providing the candidate regions for presentation to the first user.

10. The non-transitory, computer-readable medium of claim 9, the operations further comprising:
dividing, before determining the quantities of second users having the user characteristics in the respective second regions, the first region into plural second regions according to a predetermined rule;
acquiring locations of all third users in the first region within a predetermined period of time; and
acquiring user characteristics of all the third users in the first region within the predetermined period of time.

11. The non-transitory, computer-readable medium of claim 10, wherein acquiring locations of all third users in the first region within a predetermined period of time comprises:
acquiring plural second regions, including locating the third users in the first region based on when the third users log into a predetermined application within the predetermined period of time and the numbers of times each of the third users logs into the application in respective second regions; and
using, as the location of the third user, a second region in which one third user logs onto the application for the largest number of times.

12. The non-transitory, computer-readable medium of claim 10, wherein acquiring user characteristics of all the third users in the first region within the predetermined period of time comprises:
acquiring network information of the third users in the first region; and
determining the user characteristics of the third users according to the network information.

13. The non-transitory, computer-readable medium of claim 12, wherein determining the quantities of second users having the user characteristics in respective second regions comprises:
determining the third users whose locations are in respective second regions;
screening out second users having the user characteristics from the third users; and
counting the quantities of the second users.

14. The non-transitory, computer-readable medium of claim 9, wherein determining candidate regions from the plural second regions according to the quantities of the second users comprises:
determining index values of the user characteristics in respective second regions according to the quantities of the second users;
sorting the plural second regions according to the index values; and
using a top M second regions as the candidate regions, M being a predetermined numerical value.

15. The non-transitory, computer-readable medium of claim 14, wherein determining index values of the user characteristics in respective second regions according to the quantities of the second users comprises:
sorting the second regions according to an ascending order of the quantities of the second users, and sequentially assigning sequence numbers from 1 to N, wherein N is a positive integer greater than 1;
determining sequence number values corresponding to respective second regions according to the following formula: the sequence number value=(the sequence number of each second region/the total number of second regions−0.5)*2; and
determining index values corresponding to respective second regions according to the following formula: the index value=round((ASIN(sequence number value)/π+0.5)*1000).

16. The non-transitory, computer-readable medium of claim 9, wherein there are multiple user characteristics, wherein determining the quantities of second users having the user characteristics in respective second regions comprises determining the quantities of plural second users having the user characteristics in respective second regions, and wherein sorting the plural second regions according to the quantities of the second users comprises separately determining an index value of each user characteristic in respective second regions according to the quantities of the plural second users, and wherein the operations further comprise:
determining comprehensive index values of respective second regions according to the index values of the user characteristics and weights preset for the respective user characteristics:
the comprehensive index value=a*X1+b*X2+c*X3 . . . , wherein X1, X2, X3 . . . are index values of respective user characteristics, and wherein a, b, c . . . are weights of respective user characteristics; and
sorting the plural second regions according to the comprehensive index values.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, by a server, a keyword input by a first user;
determining, using at least the keyword, user characteristics;
identifying a first region, the first region comprising plural second regions;
determining, based at least on location information of users in the first region, quantities of second users in respective second regions that have the user characteristics;
determining candidate regions from the plural regions based on the quantities of the second users; and
providing the candidate regions for presentation to the first user.

18. The computer-implemented system of claim 17, the operations further comprising:
dividing, before determining the quantities of second users having the user characteristics in the respective second regions, the first region into plural second regions according to a predetermined rule;
acquiring locations of all third users in the first region within a predetermined period of time; and
acquiring user characteristics of all the third users in the first region within the predetermined period of time.

19. The computer-implemented system of claim 18, wherein acquiring locations of all third users in the first region within a predetermined period of time comprises:
acquiring plural second regions, including locating the third users in the first region based on when the third users log into a predetermined application within the predetermined period of time and the numbers of times each of the third users logs into the application in respective second regions; and
using, as the location of the third user, a second region in which one third user logs onto the application for the largest number of times.

20. The computer-implemented system of claim 19, wherein acquiring user characteristics of all the third users in the first region within the predetermined period of time comprises:
acquiring network information of the third users in the first region; and
determining the user characteristics of the third users according to the network information.
